(19) United States
(12) Patent Application Publication
(10) Pub. No.: US 2023/0385768 A1
(43) Pub. Date: Nov. 30, 2023

(54) Workspace Video Collaboration

(71) Applicant: PITCH SOFTWARE GMBH, Berlin (DE)

(72) Inventor: Jelle Akkerman, Trento (IT)

(21) Appl. No.: 18/031,450

(22) PCT Filed: Oct. 13, 2021
(86) PCT No.: PCT/EP2021/078361

§ 371 Date: Apr. 12, 2023

(30) Foreign Application Priority Data
Oct. 13, 2020 (LU) 102113

(51) Int. Cl. G06Q 10/101; H04L 65/403

(52) U.S. Cl. CPC G06Q 10/101; H04L 65/403

(57) ABSTRACT

A document collaboration system and method for generating a collaboration session. The document collaboration system comprises a display device for displaying a workspace with a document and one or more cursors having cursor positions in the document. The system is configured to enable simultaneous collaboration of multiple workstations in a collaboration session using a content data, an audio-visual media stream and a positional data. The method for generating a collaboration session comprises receiving of the content data, the audio-visual media stream and the positional data, receiving from the one or more second ones of the plurality of workstations positional data relating to the cursor positions of second ones of the one or more cursors, and generating an output of the document on the display device, wherein the audio-visual media stream is shown on the display in one or more video thumbnails representative of the audio-visual media stream.

### BACKGROUND OF THE INVENTION

### Field of the Invention

This application claims priority of Luxembourg Patent Application number LU102113, filed on 13 Oct. 2020. The entire disclosure of the Luxembourg Patent Application number LU102113 is hereby incorporated herein by reference.

The field of the invention relates to a document collaboration system and a method for generating a workspace for collaborating in online workspaces.

### BRIEF DESCRIPTION OF THE RELATED ART

Systems for collaborating on documents or in workspaces using web services and/or audio and/or video streams are well known in the art. US Patent Application US 2010/095198 A1 teaches a system that allows the editing of a shared document by multiple collaborators on a webpage. The system can receive a comment for the document by one of the collaborators. The system updates the webpage with the received comment and enables responses to the comment by other collaborators. The application, however, remains silent on the use of audio and/or video feeds in the shared document.

Different technical solutions for web-based collaboration are also known. US Patent Application US 2004/181577 A1 teaches a system and method for facilitating real-time collaboration using a real-time collaboration server. The server comprises several communication modules for handling communications with individual clients. An organizer on the server manages the collaboration and includes a control unit for each mode (e.g., desktop sharing, whiteboard, chat). Incoming communications are routed to the appropriate control unit by a filter. The control unit queues sets of collaboration data for distribution to the individual clients through separate communication modules. When one of the clients acknowl-edges receipt of one set of data, the next set of data can be sent.

US Patent Application US 2015/341399 A1 teaches a method and apparatus comprising a screen comprising a first area for displaying a video of a user and a second area for providing an editable document. The method and apparatus are configured to receive a selection corresponding to a point in time of the video and provide the editable document in a state that corresponds to the selected point in time of the video. The method and apparatus may also receive a selection of an edit of the editable document and reproduce the video from a point in time corresponding to the selected edit. The method described allows users to retroactively replay the editing of a document edited by another user.

US Patent Application U S2016/179323 A1 teaches systems, methods, and computer readable storage media for facilitating an in-place web communication related to content of a webpage. In a particular embodiment, the method provides determining that a cursor is positioned by a user over a first location on the webpage of a website displayed on the user system and receiving a user selection from the user that requests a communication with an agent system. In response to the user selection, the method enables transferring information associated with the first location to a host system.

US Patent Application US 2009/164581 A1 teaches a system and method for enabling co-browsing between two or more users accessing a website in separate sessions. Each of the users operates a web browser instance to browse the website. A collaboration manager running in the browser of each user receives the communicated changes and provides them to other co-browsing users. The system and method allow to synchronize cursors, scroll-bar positions, and other browser events.

US Patent Application US 2017/235537 A1 discloses a collaboration system and method for publication of a workspace to a computer outside of the collaboration system. The workspace comprises a plurality of graphical objects, wherein the graphical objects are, for example, video files of various types, image files of various types including Portable Network Graphics (PNG), Joint Photographic Experts Group (JPEG), Scalable Vector Graphic (SVG), and Portable Document Format (PDF) files, and richer function files such as files created using Microsoft PowerPoint, Microsoft Word, and other presentation and word processing products. Users can interact with the graphical objects of the workspace resulting in “events” that are recorded. These events can include an event identifier, a timestamp, a session identifier, an event type parameter, the client identifier, and an array of locations in the workspace. Interactions and the resulting events can include a text type event, which indicates entry, modification, or movement in the workspace of a text object. When a client creates, modifies, moves, or deletes an object by interaction with its local, a new event is created by the client-side network node and sent across the workspace channel to the server-side network node. The server-side network node saves events in the spatial event map for the session and distributes the events to all active clients in the session.

US Patent Application US 2007/198744 A1 discloses a multi-user multi-way collaboration system enabling distributed users at local workspaces to share editorial input on content such as a media resource via a server. Any local workspace includes a resource area populated with one or more resource windows. These resource windows are surrounded by a border encoded (e.g., using color or pattern or combination) to indicate which user is currently processing a particular resource or which last processed a resource. The multi-user multi-way collaboration system further comprises a system for transmitting a media resource and one or more collaboration messages over a communications network. The system for transmitting the media resource comprises a plurality of real-time messaging clients coupled to the communications network.

US Patent Application U.S. Pat. No. 9,667,676 B1 discloses a content management system (CMS) allowing users with user accounts to collaboratively edit, draft, or otherwise work with the same content item simultaneously. A user of a host device A opens a content item in a native application for editing the content item. In a collaborative editing session, the client application establishes a bi-directional data channel between the host device A and the client devices B, C. The CMS client application transmits a real-time data stream of the content item over the data channel to a screen sharing window on each of the client devices B, C. The data stream may include, e.g., video data, text data, or a combination thereof. The client device B, C may receive user inputs corresponding to edits to be made to the content item from a user of the client device. The inputs are translated into a set of interpretable command codes indicating the relative location of each input and its content, (e.g., X, Y location within the screen sharing window, command type and values) and sends the code to the CMS client application on the host device.

The CMS client application receives the command codes and translates these command codes into native commands of the native application for the content item to execute and thereby incorporate the edits made on the client device to the actual content item (e.g., a file) on the host device. The CMS also comprises displaying cursors of users participating in the collaborative editing session on each of client devices B, C to enable each user to view and follow the changes made by the other participants of the session. The screen sharing window of the client device B, C detects and transmits the cursor position of each client device B, C. The CMS client application receives coordinates for each cursor and translates the coordinates to reflect the movement and location of the cursor within the native application on the host client device. The translated position of each cursor is subsequently provided to each client device B, C to render each cursor in the transmitted data stream with the content item in the screen sharing window, thereby, allowing each user B, C to follow the changes made to the content item by other user A, B, C in real-time.

UK Patent Application GB 2 557 233 A discloses a collaboration system for multi-user information streaming. A user of a collaboration client may choose to share an information source such as a file with other users of a collaboration session. The shared information source is data-streamed to the users by means of a collaboration server. Actions of the user on the information source such as editing, scrolling, and/or highlighting are included by the collaboration server into the stream of the information.

The prior art teaches systems or methods for collaboratively editing documents online using different technical solutions e.g., showing remarks in an online document, providing audio and/or video communication, or synchronizing views across devices. The prior art does, however, not disclose systems or methods for the real time online collaboration of teams using at least one of content data sharing and a media sharing combined with real time cursor tracking.

### SUMMARY OF THE INVENTION

The present application relates to a document collaboration system and computer-implemented method enabling users to work collaboratively in a workspace. The document collaboration system and computer implemented method enables users to edit documents collaboratively and efficiently by generating a workspace in which multiple ones of the users can (substantially) simultaneously work on a single document. The document collaboration system also comprises an audio-visual media stream for direct communication of all participants in one document. The system further allows a first user to see, for example, a second user's current viewing or editing position within the document, using the second user's positional data. The second user's viewing or editing position within the workspace is indicated by a video thumbnail which allows, for example, a first user to see a video thumbnail comprising the second user's video while at the same time seeing the second user's working or editing position. Users can therefore collaborate more easily by using the document collaboration system described in further detail below.

The document collaboration system comprises a workstation, the workstation comprising a display device, a content data interface, a presence manager, a presence manager interface, a media interface, and a processor. Using the display device, a workspace with a document and one or more video thumbnails can be displayed using the display device, one or more cursors having cursor positions are displayed. The content data interface is used for receiving content data from at least one content data source. The presence manager interface is used for receiving, for example, positional data from at least one positional data source. The presence manager is configured to store the one or more cursor positions. The presence manager is configured via a presence manager interface. The presence manager is further configured to transmit to one or more further workstations at least positional data relating to the cursor positions of first ones of the one or more cursors. The presence manager is also configured to receive from the one or more further workstations at least positional data relating to the cursor positions of second ones of the one or more cursors configured via a presence manager interface. The media interface is used for receiving an audio-visual media stream from the one or more further workstations. The audio-visual media stream comprises a video stream and an audio stream. A processor combines the content data, the positional data with the audio-visual media stream and the one or more video thumbnails to generate a collaboration session of the workstation and the one or more further workstations. The positional data is indicative of the position of the video thumbnail in the workspace and is expressed in coordinates relative to the size of the document.

The document collaboration system is further configured to manage a state map for processing a plurality of presence maps, wherein the presence maps comprise the positional data. The document collaboration system further comprises a state map, wherein the state map comprises one of a presence map for the at least one further workstation connected to the collaboration session. The document collaboration system further comprises a presence channel for transmitting the state map.

The media interface is adapted to enable a peer-to-peer exchange of the at least one audio-visual media stream. In a further aspect of the present invention, centralized servers may also be used for transmission of the audio-visual media stream if the number of participants in one workspace exceeds a certain limit. The media interface is adapted to enable the exchange of at least one of a video stream and an audio stream using an audio-visual server.

The document collaboration system can further comprise an audio-visual server for receiving a plurality of audio-visual media streams and combining the plurality of audio-visual media streams into a single audio-visual media stream for transmission to individual ones of the display device.

The processor is adapted to render the content data in one layer of a browser and the audio-visual media stream in another layer of the browser.

A computer-implemented method for generating a collaboration session enabling collaboration between a plurality of workstations, the collaboration session comprising at least one workspace with a document and one or more cursors, having cursor positions in the document is also disclosed in the present document. The method comprises receiving content data from a content data source. The method also comprises transmitting to one or more second ones of the plurality of workstations positional data relating to the cursor positions of first ones of the one or more cursors. The method further comprises receiving from the one or more second ones of the plurality of workstations positional data relating to the cursor positions of second ones of the one or more cursors. The method also comprises receiving an audio-visual media stream from the one or more second ones of the plurality of workstations. The audio-visual media stream also comprises a video stream and an audio stream. An output on the display device is generated from the received content data and the received audio-visual media stream using the method, wherein the audio-visual media stream is shown on the display in one or more video thumbnails positioned at the cursor positions of the second ones of the one or more cursors in the workspace.

The method further comprises rendering the workspace in a layer in a browser. The rendering of the rendering of the content data is in one layer of the browser and the rendering of the audio-visual media stream is in another layer of the browser. The receiving of the positional data in the method further comprises calculating, using the presence manager, a state map from a presence map of the one or more further ones of the plurality of workstations connected to the collaboration session. The receiving of the positional data further comprises creating a presence map by a processor indicative of the cursor position of the first ones of the one or more cursors relative to a document in the workspace.

### BRIEF DESCRIPTION OF THE FIGURES

FIG. 1 shows a view of the connections of the document collaboration system using the positional data, the audio-visual media stream, and the content data.

FIGS. 2A and 2B show a flow chart describing a computer-implemented method for establishing an audio-visual media stream.

FIG. 3 shows a flow chart describing a computer-implemented method managing cursor positions using a presence manager.

FIG. 4 shows an example of the workspace of the document collaboration system having multiple workstations.

### DETAILED DESCRIPTION OF THE INVENTION

The invention will now be described on the basis of the figures. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

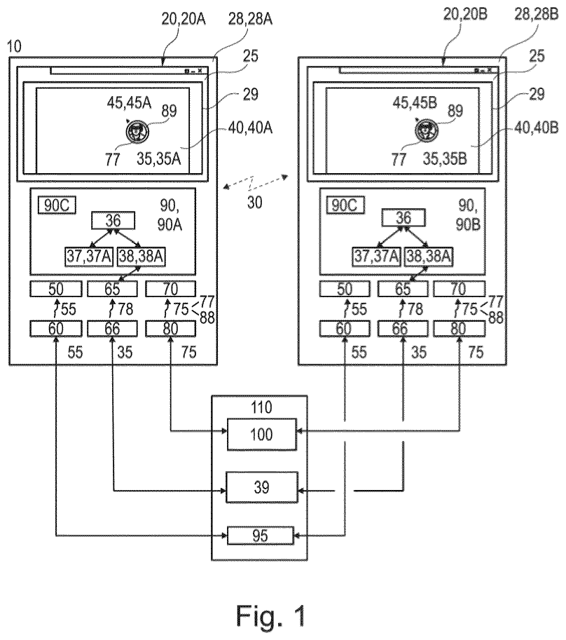

FIG. 1 shows a view of a document collaboration system 10 in a collaboration session 30 comprising at least two workstations 28 and a backend 110. The backend 110 acts as a video room management server and manages the rooms for the document collaboration system 10. The workstations 28 comprise a display device 20 for displaying a browser 25, a content data interface 50 for receiving content data 55, a presence manager interface 65 for receiving positional data 78 (and optionally further data relating to the user interface), a media interface 70 for receiving an audio-visual media stream 75, and a processor 90 for calculating a presence manager 36. The backend or video room management server 110 comprises a content server 95, a presence channel 39, and an audio-visual server 100. The presence channel 39 is an external service, for example pusher.com, but is not limited thereto. The audio-visual server 100 is also an external service, for example Daily.co, but is not limited thereto. The document collaboration system 10 enables a plurality of collaborating users to collaborate on a document 40 in a so-called “collaboration session”.

The display device 20 displays in the browser 25 a workspace 29 with the document 40 and one or more of a video thumbnail 45. Workspace 29 with the document 40 is generated by the processor 90 or by a separate graphics processor 90G.

The content data interface 50 receives content data 55 from a content data source 60. The content data source 60 is connected to the content server 95 for the exchange of content data 55 between at least two of the workstations 28. Content data 55 comprises, for example, text and/or graphics data.

The presence manager interface 65 receives positional data 78 from a positional data source 66. The positional data source 66 is connected to the presence channel 39 for exchanging of positional data 78 (and optionally other data relating to the user interfaces) between at least two of the workstations 28. The positional data 78 comprises, for example, a cursor position 35 in the document 40. Cursor position 35 is calculated by processor 90 in coordinates relative to the position of the cursor in the document 40. The cursor is, for example, the cursor of a mouse or another pointing device being displayed on display device 20 of the workstation 28. The workstation 28 is configured to track the cursor position 35 as the cursor is moved relative to the document 40. This tracking uses horizontal and vertical coordinates within the document 40.

The media interface 70 receives at least one audio-visual media stream 75 from at least one media source 80. The audio-visual media stream 75 comprises a video stream 77 and an audio stream 88 and includes a video and audio of one of the collaborating users. The video stream 77 comprises, for example, a video showing one of the collaborating users connected to the document collaboration system 10. The video stream 77 may further comprise additional visual elements relating to the user connected to the document collaboration system 10. The audio stream 88 comprises, for example, the audio for the one of the collaborating users. The media interface 70 is in one aspect of the document collaboration system 10 adapted to enable a peer-to-peer exchange of the audio-visual media stream 75 between two or more of the collaborating users in the collaboration session. Peer-to-peer exchange describes direct communication between at least two of the workstations 28 without requiring use of an audio-visual server 100 for managing the communication of the audio-visual media stream 75. In case of a peer-to-peer connection, the audio-visual server 100 is only used for the initial contacting of the workstations 28 connected to the document collaboration system 10. In a further aspect of the document collaboration system 10, the audio-visual server 100 is used for management and transferring of the audio-visual media stream 75 if the number of the workstations 28 in the collaboration session 30 exceeds a certain limit, such as five workstations 28, but this is not limiting of the invention.

The video thumbnail 45 shows the video stream 77 of one of the collaborating users and, in one aspect, an audio level indicator 89. The audio level indicator 89 is configured to be indicative of a volume level of the audio stream 88 and can, for example, change in at least one of a size, shape, color, or opacity depending on the volume level, as well as being an avatar or an icon. The audio level indicator 89 can be further configured to be selectable by a cursor in the display device 20. The audio level indicator 89 of the video thumbnail 45 can be displayed in different colors. The video stream 77 displayed in the video thumbnail 45 can further be configured to show a “microphone muted”-symbol, indicating that the corresponding audio stream 88 of the audio-visual media stream 75 is currently muted, e.g., not receiving any audio signal.

The processor 90 includes a graphics processor 90G and is used to combine the content data 55, the positional data 78 with the audio-visual media stream 75 and the one or more video thumbnails 45 to generate the workspace 29. The graphics processor 90G renders the content data 55 for display in one layer of a browser 25 and the audio-visual media stream 75 for display in another layer of the browser 25.

The presence manager 36 stores a presence map 37 and a state map 38. The presence map 37 comprises coordinates of the cursor position 35 and might further comprise items of data on other elements or areas within document 40 displayed on the display device 20 of the workstation 28. Presence map 37 comprises, for example, items of data relating to the area of document 40 selected by the user. This area can be referred to as “user selection”. Items of data relating to this user selection may also be stored in the presence map 37. State map 38 contains a copy of the presence maps 37 of the other workstations 28 connected to the document collaboration system 10.

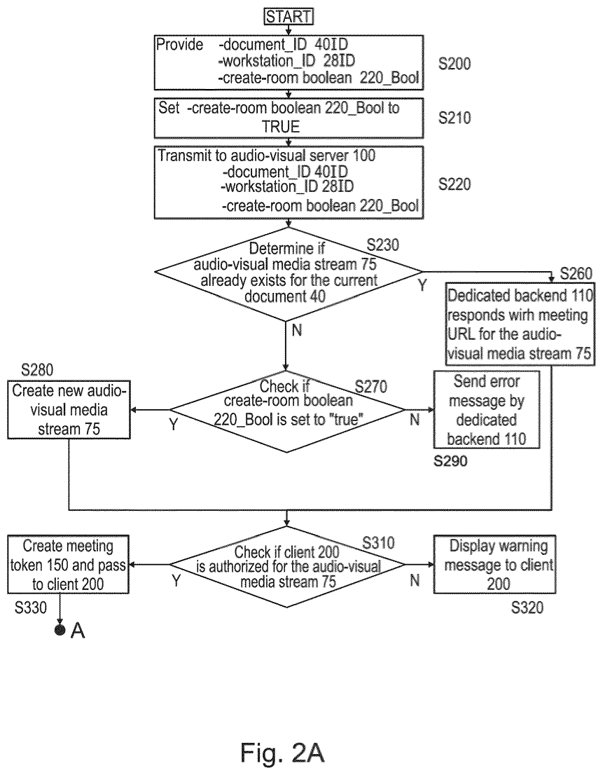

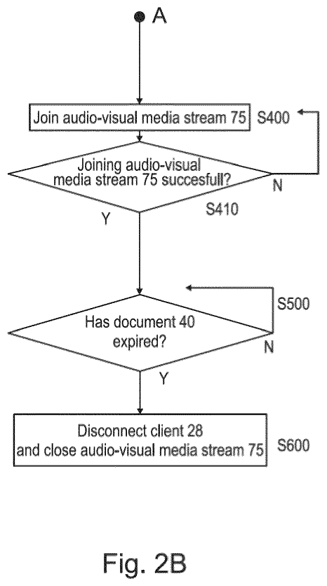

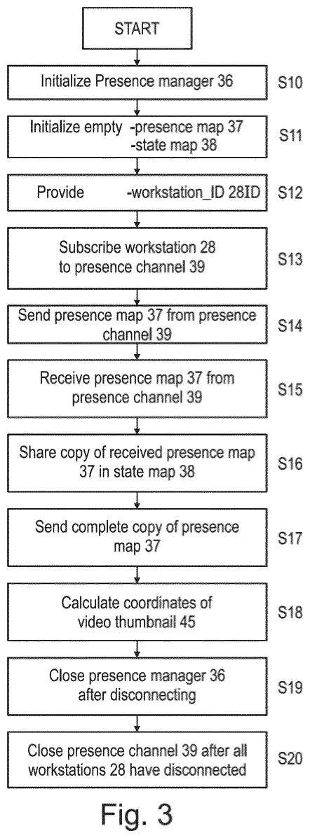

A first workstation 28A, for example, stores a first presence map 37A comprising the coordinates of a first cursor position 35A on the first display device 20A and a first state map 38A comprising a copy of a second state map 38B. The copied second state map 38B comprises the second cursor position 35B and is received from a further workstation 28B using the presence channel 39 and the presence manager interface 65. The presence manager 36 of the workstation 28 is asynchronously connected to the presence channel 39. The presence channel 39 is used to transfer state map 38 between different ones of the workstations 28, for example, between the first workstation 28A and the further workstation 28B. The method of communication will be described later with respect to FIGS. 2A, 2B, and 3.

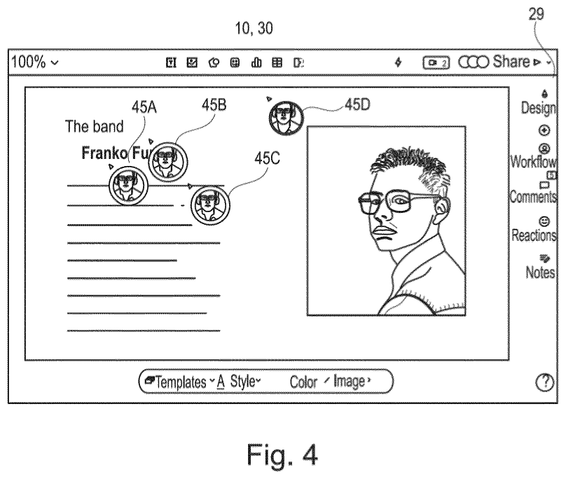

One example of the use of the document collaboration system 10 is for the drafting of a presentation (as is shown in FIG. 4). FIG. 1 shows the connections between the first workstation 28A and the further workstation 28B of the document collaboration system 10 engaged in the collaboration session 30 using the positional data 78, the audio-visual media stream 75 and the content data 55. In FIG. 1 only two of the workstations 28A and 28B are shown for simplicity. It will be appreciated that the document collaboration system 10 may include multiple ones of the workstations 28.

The first workstation 28A comprises a first processor 90A, the first display device 20A, a first document 40A, the previously-mentioned first cursor position 35A, a first video thumbnail 45A, and a presence manager 36 storing the first presence map 37A and the first state map 38A. Similarly, the further workstation 28B comprises a second processor 90B, the second display device 20B, a second document 40B, the second cursor position 35B, a second video thumbnail 45B, and a presence manager 36 storing a second presence map 37B and a second state map 38B.

The second cursor position 35B is stored in the second presence map 37B in the further workstation 28B (as described above). The second presence map 37B is copied across to the first state map 38A in the first workstation 28A through and the presence channel 39 (as described in FIG. 3). The presence manager 38A in the first workstation 28A is able to access both the first presence map 37A and the first state map 38A (now containing a copy of the second presence map 37B with the location of the second cursor position 35B) and is then able to display both the first cursor position 38A and the second cursor position 38B on the first display device 20A. As already noted, workspace 29 displayed on the first display device 20 is generated using the first processor 90A. The position of the first video thumbnail 45A is displayed on the first display device 20A using the second cursor position 35B stored in the first state map 38A.

Similarly, the position of the second video thumbnail 45B is displayed on the second display device 20B by using the method described. This method enables the depiction of the first video thumbnail 45A and the second video thumbnail 45B at the corresponding cursor positions 35A and 35B on the display devices 20A and 20B on the two workstations 28A and 28B in the collaboration session 30. It will be understood from the above that, if more than two of the workstations 28 are connected to the collaboration session 30, the plurality of workstations 28 display on their own display device 20 one video thumbnail 45 for each of the connected workstations 28.

The further workstations 28B may comprise a plurality of further workstations 28B being connected to the document collaboration system 10. In case a plurality of further workstations 28 are connected to the document collaboration system 10, a plurality of video thumbnails 45 are displayed on the display device 20A of, for example, the first workstation 28A. One video thumbnail 45 is displayed on, for example, the display device 20A of the first workstation 28A for each of the further workstations 28B connected to the document collaboration system 10 using respective cursor positions 35B.

In a further example of the present invention, the first workstation 28A can be configured in a so-called “follow mode” to follow the first video thumbnail 45A displayed on the first display device 20A. The first workstation 28A is configured to display a part of the first document 40A that is currently being viewed or edited by the further workstation 28B as indicated by the second cursor position 35B when in “follow mode”. The workstations 28 connected to the collaboration session 30 can be configured to follow different ones of the video thumbnails 45 when in “follow mode”.

FIG. 2A shows a flow chart illustrating a computer-implemented method for establishing the audio-visual media stream 75. In step S200, a document-ID 401D, a workstation-ID 281D, and a create-room Boolean 220_BOOL are provided by processor 90. The docu-ment-ID 401D identifies document 40. The workstation-ID 281D identifies the workstation 28 and is used to associate the audio-visual media stream 75 with the workstation 28 connected to the audio-visual media stream 75. There can only one audio-visual media stream 75 per document 40 at any time. The create-room Boolean 220_BOOL indicates whether a new audio-visual media stream 75 should be created for the document 40 if no previous audio-visual media stream 75 exists.

The processor 90 sets the create-room Boolean 220_BOOL to “true” if a new audio-visual media stream 75 should be created. This is shown in step S210. In step S220, the document-ID 401D, the workstation-ID 281D, and the create-room Boolean 220_BOOL are transmitted to the audio-visual server 100 using the media interface 70.

The existence of a previous audio-visual media stream 75 for the document 40 is checked in step S230, using the audio-visual server 100 and the generated document-ID 40ID. If a previous audio-visual media stream 75 is set, the audio-visual server 100 will respond with a URL indicating the address of the previous audio-visual media stream 75. This URL enables the workstation 28 to join the previous audio-visual media stream 75 as shown in step S260.

In step S270, a check for the create-room Boolean 220_BOOL will be conducted if no previous audio-visual media stream 75 exists for document 40. The audio-visual server 100 will create, as shown in step S280, a new audio-visual media stream 75 if the create-room Boolean 220_BOOL is set to “true”. Initializing the new audio-visual media stream 75 comprises establishing the audio-visual media stream 75 with the media interface 70 of the document collaboration system 10. The connection is established using standardized internet communication protocols, such as protocols defined in the RFC publications. If the create-room Boolean 220_BOOL is set to “false”, the audio-visual server 100 will respond with an error indicating that the audio-visual media stream 75 could not be found, as shown in step S290.

The audio-visual server 100 checks an authorization of the workstation 28 to access the document 40 in step S310, using the existing authorization rules for the accessing of the document 40. If a workstation 28 does not have access to document 40, access to the audio-visual media stream 75 is also denied and a warning is displayed, as shown in step S320. If workstation 28 has access to the document 40, access to the audio-visual media stream 75 will be granted by the audio-visual server 100.

Granting the workstation 28 access to the audio-visual media stream 75 comprises the creation of a meeting token 150 by the backend/video room management server 110 in step S330. The meeting token 150 comprises the document-ID 40ID, the workstation-ID 28ID, a username for the workstation 28 and an expiration time of the token 150. The meeting token 150 is configured to expire after a certain time, for example, a few minutes. Upon expiration, the meeting token 150 no longer enables the workstation 28 to access the audio-visual media stream 75.

In step S400 in FIG. 2B an attempt is made to join the audio-visual media stream 75 using the meeting token 150. Joining the audio-visual media stream 75 comprises sending a request to join from one of the workstations 28 to the audio-visual server 100. The audio-visual server 100, using the meeting token 150, connects the requesting one of the workstations 28 to the audio-visual media streams 75 connected ones of the workstations 28 using WebRTC handshakes. The audio-visual media stream 75 is, depending on the number of the workstations 28 in the collaboration session 30, established either using the peer-to-peer connection or the audio-visual server 100 (as described above). In step S410 a check is conducted to verify if the audio-visual media stream 75 was joined successfully. Step S400 is reiterated several times should the attempt to join the audio-visual media stream 75 fail. Should the attempt to join the audio-visual media stream 75 in step S400 succeed, the audio-visual media stream 75 is kept alive until the document 40 expires, as shown in step S500, or a time interval of no activity has elapsed (e.g., 24 hours). In step S600, the workstations 28 connected to the audio-visual media stream 75 are disconnected from the audio-visual media stream 75 by the processors 90 of the workstations 28. After workstations 28 have been disconnected from the audio-visual media stream 75, the audio-visual media stream 75 for the document 40 is closed.

FIG. 3 shows a flow chart describing a computer-implemented method for managing of the cursor positions 35 using the presence manager 36. The workstations 28 connected to the document collaboration system 10 initialize the presence manager 36 upon joining the collaboration session 30 in step S10, using the processor 90, as described above. The processor 90 creates an empty presence map 37 and an empty state map 38 in step S11 in a memory of the workstation 28.

In step S12 the processor 90 accesses the workstation-ID 28ID. The presence manager 36 of the workstation 28 then asynchronously subscribes to the presence channel 39 in step S13. Upon successful subscription of the presence manager 36 to the presence channel 39, the presence manager 36 broadcasts a copy of its presence map 37, in step S14, to the presence channel 39 for receipt by other ones of the workstation 28. The other ones of the workstation 28 receive the broadcast presence map 37 using the presence manager 36 of the other ones of the workstations 28 in step S15. After subscription and initial broadcasting of the copy of its presence map 37, the workstation 28 and the presence manager 36 only need to broadcast a description of changes in the presence map 37 to the presence channel 39. To save data traffic, the broadcasting is limited to 10 broadcasts/sec, but this is not limiting the invention.

Any further new ones of the workstations 28 joining the collaboration session 30 will subscribe to the presence channel 39 using the abovementioned steps S10 to S14. The newly joined workstation 28 similarly broadcasts the copy of its current presence map 37. The workstations 28 currently subscribed to the presence channel 39 receive the broadcast copy of the presence map 37 of the newly joined workstation 28 in step S15. The workstations 28, on receiving the broadcast copy of the presence map 37 from the newly joined workstation 28, store the copy in their state map 38 in step S16.

It is now necessary for the newly joined workstation 28 to receive copies of the presence maps 37 from the existing workstations 28 in the collaboration system 10 so that the newly joined workstation 28 is able to produce the document 40 with the video thumbnails 45 and content on its display device 20. The existing workstations 28 know, from receipt of the copy of the presence map 37 from the newly joined workstation 28, that it is necessary for the newly joined workstation 28 to be provided with items of data about the document 40 (including the content and the cursors positions 35) on which the workstations 28 in the collaboration system 10 are working. This requires the newly joined workstation 28 to receive the copies of the presence maps 37 from the other workstations 28. This is done in step S17 in which the existing workstations 28 broadcast the copy of their presence maps 37 to the presence channel 39, as described in step S14. The newly joined workstation 28 receives the broadcast presence maps 37 and stores the received presence maps 37 in its state map 38 (similar to steps S15 and S16)

In step S18, the processor 90 generates, for example, the position of the first video thumbnail 45A displayed on the first display device 20A using the calculated coordinates indicating the second cursor position 35B, as described in the explanation of FIG. 1. The presence manager 36 of the workstation 28 is closed in step S19 once the workstation 28 disconnects from the document collaboration system 10. The presence channel 39 is closed in step S20 once the presence managers 36 have disconnected from the presence channel 39.

FIG. 4 shows an example of workspace 29 of the document collaboration system 10 displaying multiple ones of the video thumbnails 45. Each of the video thumbnail 45 indicates one workstation 28 connected to the collaboration session 30 in the document collaboration system 10. In the example of FIG. 4, four of the video thumbnails 45, the first video thumbnail 45A, the second video thumbnail 45B, a third video thumbnail 45C, and a fourth video thumbnail 45D are displayed in workspace 29. The video thumbnails 45A-45D are displayed at the same cursor positions 35 in all of the workspaces 29 connected to the document collaboration system 10.

### REFERENCE NUMERALS

10 document collaboration system
20 display device
20A first display device
20B second display device
25 browser
28 workstation
28A first workstation
28B further workstation
281D workstation-ID
29 workspace
30 collaboration session
35 cursor position
35A first cursor position
35B second cursor position
36 presence manager
37 presence map
37A first presence map
37B second presence map
38 state map
38A first state map
38B second state map
39 presence channel
40 document
40A first document
40B second document
401D document-ID
45 video thumbnail
45A first video thumbnail
45B second video thumbnail
45C third video thumbnail
45D fourth video thumbnail
50 content data interface
55 content data
60 content data source
65 presence manager interface
66 positional data source
70 media interface
75 audio-visual media stream
77 video stream
78 positional data
80 media source
88 audio stream
89 audio level indicator
90 processor
90A first processor
90B second processor
90G graphics processor
95 content server
100 audio-visual server
110 backend/video room management server
150 meeting token
220_BOOL create-room Boolean

1. A document collaboration system comprising a plurality of workstations, the workstations comprising:
a display device for displaying a workspace with a document and one or more cursors having cursor positions in the document;
a content data interface for receiving content data from at least one content data source;
a presence manager configured to store the one or more cursor positions, the presence manager being configured via a presence manager interface to transmit to one or more further workstations at least positional data relating to the cursor positions of first ones of the one or more cursors and to receive from the one or more further workstations at least positional data relating to the cursor positions of second ones of the one or more cursors, wherein the presence manager is further configured to manage a state map for processing a plurality of presence maps, wherein the presence maps comprise the positional data;
a media interface for receiving an audio-visual media stream from the one or more further workstations, the audio-visual media stream comprising a video stream and an audio stream, wherein the audio-visual media stream is shown on the display in one or more video thumbnails positioned at the cursor positions of the second ones of the one or more cursors in the workspace; and
a processor for combining the content data with the positional data, the audio-visual media stream and the one or more video thumbnails to generate a collaboration session of the workstation and the one or more further workstations.

2. The document collaboration system of claim 1, wherein the positional data is expressed in coordinates relative to the size of the document.

3. (canceled)

4. The document collaboration system of claim 1, the presence manager further comprising a state map, the state map comprising one of a presence map for the at least one further workstation connected to the collaboration session.

5. The document collaboration system of claim 1, further comprising a presence channel for transmitting the state map.

6. The document collaboration system of claim 1, wherein the media interface is adapted to enable a peer-to-peer exchange of the at least one audio-visual media stream.

7. The document collaboration system (10) of claim 1, wherein the media interface is adapted to enable the exchange of at least one of a video stream and an audio stream using an audio-visual server.

8. The document collaboration system of claim 6, further comprising an audio-visual server for receiving a plurality of audio-visual media streams and combining the plurality of audio-visual media streams into a single audio visual media stream for transmission to individual ones of the display device.

9. The document collaboration system of claim 1, wherein the processor is adapted to render the content data in one layer of a browser and the audio-visual media stream in another layer of the browser.

10. A computer-implemented method for generating a collaboration session enabling collaboration between a plurality of workstations, the collaboration session comprising at least one workspace with a document and one or more cursors, having cursor positions in the document, displayed on a display device of a first one of the plurality of workstations, the computer-implemented method comprising:
receiving content data from at least one content data source;
transmitting to one or more further ones of the plurality of workstations positional data relating to the cursor positions of first ones of the one or more cursors;
receiving from the one or more further ones of the plurality of workstations positional data relating to the cursor positions of second ones of the one or more cursors;
receiving at least one audio-visual media stream from the one or more further ones of the plurality of workstations, the audio-visual media stream (75) comprising a video stream and an audio stream; and
generating an output of the document on the display device from the received content data and the received audio-visual media stream, wherein the audio-visual media stream is shown on the display in one or more video thumbnails (45) positioned at the cursor positions of the second ones of the one or more cursors in the workspace.

11. The method of claim 10, comprising rendering the workspace in a layer in a browser.

12. The method of claim 11, wherein the rendering of the content data is in one layer of the browser and the rendering of the audio-visual media stream is in another layer of the browser.

13. The method of claim 10, wherein the receiving the positional data comprises:
calculating, using the presence manager, a state map from a presence map the one or more further ones of the plurality of workstations connected to the collaboration session.

14. The method of claim 10, wherein the receiving the positional data comprises:
creating a presence map by a processor indicative of the cursor position of the first ones of the one or more cursors relative to a document in the workspace.
